(19) United States
(12) Patent Application Publication
(10) Pub. No.: US 2013/0209785 A1
(43) Pub. Date: Aug. 15, 2013

(54) Item Comprising a Mesoporous Layer Protected by a Coating Acting as a Barrier to the Sebum, and Production Method

(71) Applicants: Mamonjy Cadet, Charenton-le-Pont (FR); Mathieu Feuillade, Singapore (SG)

(72) Inventors: Mamonjy Cadet, Charenton-le-Pont (FR); Mathieu Feuillade, Singapore (SG)

(73) Assignee: ESSILOR INTERNATIONAL (COMPAGNIE GENERALE D'OPTIQUE), Charenton-le-Pont (FR)

(21) Appl. No.: 13/879,294

(22) PCT Filed: Oct. 11, 2011
(86) PCT No.: PCT/FR2011/052373

§ 371 Date: Apr. 12, 2013

(30) Foreign Application Priority Data
Oct. 12, 2010 (FR) 1058306

(51) Int. Cl. G02B 1/10; G02C 7/02

(52) U.S. Cl. CPC G02B 1/105; G02C 7/022
USPC 428/315.9; 427/162; 351/159.01

(57) ABSTRACT

The invention relates to an article comprising a substrate coated with a mesoporous coating and a coating acting as a barrier to sebum, having a thickness lower than or equal to 20 nm, directly deposited on the mesoporous coating, and comprising at least one silica-based layer, said silica-based layer having a thickness of at least 5 nm, comprising at least 90% by weight of silica, relative to the layer total weight, and having been deposited by physical vapor deposition. The invention also relates to a method for preparing such an article and to the use of a coating acting as a barrier to sebum as defined above in order to prevent the penetration of sebum into the porosity of a mesoporous coating formed on a main surface of the substrate of an article.

The present invention generally relates to mesoporous coatings with a low refractive index, the refractive index of which has been stabilized against external pollutants such as sebum. They are mainly intended to be provided on substrates made of organic or mineral glass, especially in the ophthalmic optics field, in particular on ophthalmic lenses for spectacles.

Increasingly, the trend is seeking to functionalize articles made of mineral or organic glass, by depositing onto the surface thereof coatings that are a few nanometers or micrometers thick in order to impart the same a given property depending on the intended use. Thus, anti-reflection, abrasion-resistant, scratch-resistant, impact-resistant, anti-fogging, anti-fouling or antistatic layers can be provided.

As used herein, an anti-reflection coating is defined as being a coating, deposited onto the surface of an article, which improves the anti-reflective properties of the end article. It makes it possible to reduce the light reflection at the article-air interface over a relatively broad part of the visible spectrum.

According to the standards used in ophthalmic optics, an article provided with anti-reflective properties has a reflection value Rv that is lower than or equal to 2.5% per face.

When a mesoporous layer is used in an anti-reflection stack, it normally forms the outer layer of this stack. The use of mesoporous layers can be easily understood when considering a monolayered anti-reflection coating, since it is preferred for such coating to have an optical thickness of λ/4, λ corresponding to a wavelength, and a refractive index equal to the geometric mean of the refractive indices of the surrounding environments, that is to say air and substrate. For a substrate with a refractive index equal to 1.5, knowing that the refractive index of air is equal to 1, the layer's refractive index should be equal to 1.22. Since such a refractive index cannot be obtained by using thin solid layers, one is seeking to approach it best by employing porous layers, the refractive index of which in essence is lower.

Preparing mesoporous coatings having a silica based matrix possessing a low refractive index due to their high porosity is well known and has been described for instance in the applications WO 2006/021698, WO 2007/088312 and WO 2007/090983, in the applicant's name. The application WO 2006/021698 describes in particular the use of mesoporous layers in anti-reflection coatings.

In the case of a multilayered anti-reflection coating, composed of layers with a high refractive index and with a low refractive index, using a layer with a very low refractive index as the stack's outer layer comes out in favor of a very effective anti-reflection coating. The performances of the anti-reflection coating are further improved when said layer with a very low refractive index is deposited onto a high refractive index-layer.

Moreover, should the mesoporous layer not be used as the outer layer, depositing additional layers by means of any liquid-mediated conventional method could induce a filling of the porosity thereof and thus a loss of its low refractive index properties.

Such positioning of the mesoporous coating in an external position makes it very sensitive to external pollutants such as sebum for instance. Once the coating's porosity has been polluted through the penetration of various pollutants, the refractive index of the mesoporous coating increases and one can observe that its anti-reflective performances do decrease.

The use of protective layers or barriers in optics has already been described.

The application WO 03/057641 describes the use of layers of metal fluorides or metal hydroxides for ensuring the protection of a thin organic or inorganic outer layer against energetic and/or reactive species.

The application WO 2004/016822 describes the use of silica layers deposited under ionic assistance and having generally a 10 nm-thickness for stabilizing the refractive index of a SiOₓF_{y} underlying layer. These protective layers would prevent water from the ambient air from penetrating into the silicon oxyfluoride layer, which would result in the diffusion of fluorinated species outside this layer.

The application WO 00/10934 describes a method for improving the durability of a porous anti-reflection coating, in other words its adhesion and abrasion-resistance properties, consisting in depositing onto said coating a 5 to 250 nm-thick cured layer of a composition comprising metal oxide particles and tetraalkyl-orthosilicate such as tetramethoxysilane, then a hydrophobic coating based on fluorinated polymers and perfluoroalkyl organosilanes preferably with a thickness ranging from 1 to 40 nm. In this application, the protective layer as a drawback suffers from being deposited by means of a liquid-mediated method.

No solution has been proposed heretofore to stabilize the refractive index of a mesoporous coating against external pollutants.

It is thus an object of the present invention to provide an article comprising a mesoporous coating, the refractive index of which is not affected by fouling and is stable over time.

It is a further object of the present invention to provide an article coated with an anti-reflection coating comprising a mesoporous layer having a low refractive index-layer, the refractive index of which is not affected by fouling and is stable over time.

It is still another object of the present invention to provide a method for making a stabilized mesoporous coating, that is to say the refractive index of which is stable over time and is not affected by fouling.

These technical issues have been solved according to the invention by designing a specific impermeable, protective layer, which is capable of protecting the pores of a mesoporous coating against external pollutants, acting especially as a barrier to sebum, while allowing to preserve any optional anti-reflective properties.

A barrier layer, the composition and deposition method of which have been developed by the present inventors, is deposited directly onto the mesoporous coating.

Such objectives are thus aimed at, according to the invention, through an article, preferably an optical article, comprising a substrate having a main surface coated with a mesoporous coating, and a coating acting as a barrier to sebum having a thickness lower than or equal to 20 nm, directly deposited onto the mesoporous coating, comprising at least one silica-based layer, said silica-based layer having a thickness of at least 5 nm, comprising at least 90%, preferably at least 95% and more preferably 100% by weight of silica, relative to the layer total weight, and having been deposited by physical vapor deposition, preferably by evaporation under vacuum.

The present invention further relates to a method for making an article comprising a substrate, the main surface of which is coated with a mesoporous coating, the refractive index of which is stable over time, comprising in forming by physical vapor deposition, more preferably by evaporation under vacuum, a coating acting as a barrier to sebum such as defined above directly onto said mesoporous coating.

The present invention further relates to the use of a coating acting as a barrier to sebum such as defined above to prevent the sebum penetration into the pores of a mesoporous coating formed on a substrate's main surface of an article.

As used herein, when an article comprises one or more coating(s) on the surface thereof, “depositing a layer or a coating onto the article” means that a layer or a coating is deposited onto the uncovered (exposed) surface of the article external coating, that is to say the coating that is the most distant from the substrate.

As used herein, a coating that is “on” a substrate/coating or which has been deposited “onto” a substrate/coating is defined as a coating that (i) is positioned above the substrate/coating, (ii) is not necessarily in contact with the substrate/coating, that is to say one or more intermediate coating(s) may be interleaved between the substrate/coating and the relevant coating (however, it does preferably contact said substrate/coating), and (iii) does not necessarily completely cover the substrate/coating. When “a layer 1 is said to be located under a layer 2”, it should be understood that layer 2 is more distant from the substrate than layer 1.

The article prepared according to the invention comprises a substrate, preferably a transparent one, having at least two main faces, at least one of which is provided with a mesoporous coating stabilized by a coating acting as a barrier to sebum.

A coating is considered as providing an efficient barrier to the sebum penetration in a mesoporous coating when this protection is effective for at least 24 hours of a continuous exposure of the mesoporous coating to sebum. This may be experimentally confirmed, by using techniques such as infrared spectroscopy, optical microscopy or by assessing the stability over time of the refractive index of the mesoporous coating.

Although the article of the invention may be any optical article, such as a screen, glazing used for example in the field of aeronautics, automotive, building or interior arrangement; an optical fiber, an insulating material for microelectronic or a mirror, it is preferably an optical lens, more preferably an ophthalmic lens, for spectacles, or an optical or ophthalmic lens blank. The lens may be a polarized lens or a photochromic lens.

The anti-reflection coating of the invention may be formed on at least one of the main faces of a bare substrate, that is to say uncoated, or on at least one of the main faces of a substrate already coated with one or more functional coating(s).

The substrate for the article of the invention may be a mineral or an organic glass, for instance an organic glass made from a thermoplastic or thermosetting plastic.

To be mentioned as especially preferred classes of substrates are poly(thiourethanes), polyepisulfides and resins resulting from polymerization or (co)polymerization of alkylene glycol bis allyl carbonates. Those monomers are marketed, for instance, under the trade name CR-39® by the PPG Industries company. The corresponding marketed lenses are referred to as ORMA® lenses from ESSILOR.

In some applications, it is preferred that the substrate's main surface be coated with one or more functional coating(s) prior to applying the mesoporous coating. These functional coatings classically used in optics may be, without limitation, an impact-resistant primer, an abrasion-resistant and/or scratch-resistant coating, a polarized coating, a photochromic coating, an antistatic coating or a tinted coating, especially an impact-resistant primer layer coated with an abrasion and/or scratch-resistant layer.

The mesoporous coating is preferably directly deposited onto the substrate or onto an abrasion and/or scratch-resistant coating.

Prior to applying the abrasion-resistant and/or scratch-resistant coating, a primer coating improving the impact resistance and/or the adhesion of the further layers in the final product may be deposited onto the substrate.

Primer coatings improving the impact resistance and abrasion-resistant and/or scratch-resistant coatings may be selected from those described in the application WO 2007/088312.

Prior to applying the mesoporous coating onto the substrate optionally coated for instance with an abrasion-resistant and/or scratch-resistant coating, it is common to submit the—optionally coated—surface of said substrate to a physical or a chemical activation treatment, intended to increase the adhesion of the mesoporous coating. Such pretreatment is generally conducted under vacuum. It may come as a bombardment with energetic species and/or reactive species, for instance an ion beam (“Ion Pre-Cleaning” or “IPC”), a treatment through corona discharge, ion spallation, an UV treatment or a plasma treatment under vacuum, generally with oxygen or argon. It may also come as a surface treatment using an acid or a base and/or solvents (water or organic solvent). Several of these treatments may be combined. These pretreatments may also be effected on the surface of one or more layer(s) of the stack prior to depositing the next layer.

As used herein, “energetic species (and/or reactive species)” are intended to mean in particular ionic species with an energy ranging from 1 to 300 eV, more preferably from 1 to 150 eV, more preferably from 40 to 150 eV. Energetic species may be chemical species such as ions, radicals or species such as photons or electrons.

The substrate's surface pretreatment that is preferred is a treatment through ionic bombardment, by means of an ion gun, where ions are particles constituted of gas atoms from which one or more electron(s) have been extracted.

The mesoporous coating will now be described. It is preferably a sol-gel mesoporous coating having a matrix comprising —Si—O—Si— chain members.

A matrix is preferably used, which is obtained from a composition containing a precursor comprising at least one silicon atom bound to 4 hydrolyzable (or hydroxyl) groups.

The matrix forming the mesoporous coating also generally comprises polysiloxane chain members, having hydrocarbon groups bound to silicon atoms.

In the present application, the mesoporous materials (coatings or films) are defined as solids comprising within the structure thereof pores with a size ranging from 2 to 50 nm, called mesopores, that is to say that at least part of their structure comprises mesopores. These have preferably a size ranging from 3 to 30 nm. Such a pore size is intermediate between the one of macropores (size >50 nm) and the one of micropores (size <2 nm, materials of the zeolite type). These definitions are those of the IUPAC Compendium of Chemistry Terminology, 2^{nd} Ed., A. D. McNaught and A. Wilkinson, R S C, Cambridge, UK, 1997.

The mesopores may be empty, that is to say filled with air, or be only partly empty. The coating is said to be mesoporous if at least part of this coating is mesoporous in nature.

Mesoporous materials and their preparation have been widely described in the literature, especially in Science 1983, 220. 365371 or The Journal of Chemical Society, Faraday Transactions 1985, 81, 545-548.

A method for preparing mesoporous coatings with a matrix comprising —Si—O—Si—chain members (silica-based matrix) is described in more detail in the patent applications WO 2006/021698, WO 2007/088312 and WO 2007/090983 in the applicant's name, which are incorporated herein by reference.

The traditional method for preparing mesoporous films is the sol-gel process. It comprises the preparation of a not much polymerized sol based on an inorganic material such as silica obtained from one or more precursor(s), such as tetraalkoxysilanes, especially tetraethoxysilane (TEOS), that were co-hydrolyzed most of the time in an acidic medium, in the presence of a pore-forming agent. This sol also contains water, an organic solvent generally polar in nature, such as ethanol, and optionally a hydrolysis and/or a condensation catalyst.

A film made from such precursor sol is then deposited onto a support main surface, and the deposited film is thermally consolidated. Removing the pore-forming agent, when used in a sufficient amount, provides a mesoporous film.

In the present application, a material may be referred to as being mesoporous as soon as the pore-forming agent used for preparing the same has been removed at least partially from at least part of this material, that is to say at least part of this material comprises mesopores that are at least partially empty. Preferably, 100% of the mesopores in the material are empty.

A suitable sol to be used in the present invention to form the —Si—O—Si— chain member-containing mesoporous matrix comprises:

at least one inorganic precursor agent of formula: Si(X)₄ (I)

wherein the X groups, being the same or different, are hydrolyzable groups selected preferably from —O—R alkoxy, in particular C₁-C₄ alkoxy, —O—C(O)R acyloxy groups, wherein R is an alkyl radical, preferably a C₁-C₆ alkyl radical, preferably a methyl or an ethyl radical, and halogens such as Cl, Br and I, and combinations of these groups; or a hydrolyzate of this precursor agent;

at least one organic solvent, at least one pore-forming agent, water and optionally a hydrolysis catalyst for the X groups.

Preferably, the X groups are alkoxy groups, and in particular methoxy or ethoxy, and more preferably ethoxy groups.

Preferred compounds (I) are tetraalkyl orthosilicates. Amongst them, tetraethoxysilane (or tetraethyl orthosilicate) Si(OC₂H₅)₄ abbreviated TEOS, tetramethoxysilane Si(OCH₃)₄ abbreviated TMOS, or tetra-isopropoxysilane Si(OC₃H₇)₄ abbreviated TPOS will be advantageously used, and preferably TEOS.

The medium containing the precursor agents is generally an acidic medium, which acidic character is provided through addition, for example, of a mineral acid, generally HCl or an organic acid such as acetic acid, preferably HCl. Such an acid acts as a hydrolysis and condensation catalyst by catalyzing the hydrolysis of the hydrolyzable groups present in the precursor agents.

Suitable organic solvents or combinations of organic solvents for use in the preparation of the precursor sol according to the invention include all the solvents that are classically used, and more particularly polar solvents, especially alkanols such as methanol, ethanol, isopropanol, isobutanol, n-butanol and mixtures thereof. Ethanol is the preferred organic solvent.

The pore-forming agent in the precursor sol may be an amphiphilic or non amphiphilic pore-forming agent. Generally, it is an organic compound.

Suitable non amphiphilic pore-forming agents to be used in the present invention include synthetic polymers such as ethylene polyoxides or ethers thereof, poly(alkylenoxy)alkyl-ethers, polyethylene glycols, diblock- or triblock-copolymers of ethylene oxide (PEO) and propylene oxide (PPO).

The pore-forming agent is preferably an amphiphilic agent of the surfactant type, such as cetyltrimethylammonium bromide. The surfactant compounds for use in the present invention are those described in the application WO 2007/088312.

The step of depositing the precursor sol film onto the main surface of the substrate may be carried out using any liquid-mediated conventional method, for example through dip coating, spray coating or spin coating, preferably through spin coating.

The step of consolidating the film structure of the deposited precursor sol consists in completing the removal of the solvent or mixture of organic solvents from the precursor sol film and/or the possible water excess, and in continuing the condensation of some residual silanol groups that are present in the sol, generally by heating said film. This step is preferably carried out by heating at a temperature ≦150° C., preferably ≦130° C., more preferably ≦120° C. and even more preferably ≦110° C.

The pore-forming agent removal step may be partial or complete, preferably complete. Such removal is effected by any suitable method, for example through high temperature calcination (heating at a temperature generally of about 400° C.), but preferably through methods enabling to work at low temperatures, that is to say at a temperature ≦150° C., preferably ≦130° C., more preferably ≦120° C. and even more preferably ≦110° C. A solvent extraction is most preferably implemented.

The various ways to remove the pore-forming agent are described in more detail in the application WO 2007/090983.

The mesoporous material matrix of the invention preferably has a hydrophobic character, which is preferably obtained by implementing at least one of the two following embodiments.

In a first embodiment, the hydrophobic character may be provided to the matrix by introducing at least one hydrophobic precursor agent carrying at least one hydrophobic group into the precursor sol previously defined, before the step of depositing a precursor sol film.

As used herein, “hydrophobic groups” are intended to mean combinations of atoms that are not prone to association with water molecules, especially through hydrogen bonding. These are generally non polar organic groups, with no charged atoms. Alkyl, phenyl, fluoroalkyl, perfluoroalkyl, (poly)fluoro alkoxy[(poly)alkylenoxy]alkyl, trialkylsilyloxy groups are therefore included in this category. Alkyl groups are the most preferred hydrophobic groups.

Hydrophobic precursor agents are preferably added to the precursor sol as a solution in an organic solvent and are preferably selected from compounds and mixtures of compounds of formulas (II) or (III) such as described in the application WO 2007/090983.

Preferred hydrophobic precursor agents are silanes, in particular alkoxysilanes, carrying at least one hydrophobic group that is directly in contact with the silicon atom. Suitable alkoxysilanes for use include alkyltrialkoxysilanes, such as methyltriethoxysilane (MTEOS, CH₃Si(OC₂H₅)₃), vinylalkoxysilanes, fluoroalkyl alkoxysilanes, and arylalkoxysilanes. The particularly preferred hydrophobic precursor agent is methyltriethoxysilane (MTEOS).

In a second embodiment, which is the preferred embodiment, the hydrophobic character may be provided to the (silica-based) matrix of the invention containing —Si—O—Si chain members, by treating the mesoporous film, which preparation has been described hereabove, with at least one hydrophobic reactive compound carrying at least one hydrophobic group. Said hydrophobic reactive compound is prone to react with the silanol groups of the matrix and treating through this compound results in a silica matrix, at least part of the silanol groups of which have been derivatized to hydrophobic groups.

The definition for hydrophobic groups is the same as the one used for the previously defined hydrophobic precursor agents.

This additional treating step, called “post-synthetic grafting”, is carried out after the step of depositing the film of the precursor sol onto a support's main surface or after the step of consolidating the deposited film. It may be carried out during, after or even before the pore-forming agent removal step.

The hydrophobic reactive compounds bearing at least one hydrophobic group particularly suitable for the present invention are compounds of a tetravalent metal or metalloid, preferably silicon, comprising at least one function capable of reacting with the hydroxyl groups that remain in the film, in particular a Si—Cl, Si—NH—, Si—OR function, where R is an alkyl, preferably a C₁-C₄ alkyl group.

Preferably, said hydrophobic reactive compound is selected from compounds and mixtures of compounds of formula (IX) described in the patent application WO 2007/088312.

1,1,1,3,3,3-hexamethyldisilazane (CH₃)₃Si—NH—Si(CH₃)₃, abbreviated HMDS, is the most preferred hydrophobic reactive compound.

This post-synthetic grafting step is described in more detail in the patent applications US 2003/157311 and WO 2007/088312.

However, the coatings of the invention have preferably a matrix comprising —Si—O—Si— chain members prepared from a sol devoid of any hydrophobic precursor agent, carrying at least one hydrophobic group. In this embodiment, the matrix of the mesoporous coating formed during the initial polymerization step is not a matrix possessing a hydrophobic character, but it acquires such character as a result of a hydrophobic post-treatment.

The mesoporous coatings of the invention having a hydrophobic matrix demonstrate a better stability over time of their properties, especially of their refractive index towards ambient humidity.

In their final state, the mesoporous films of the invention have a thickness which is not particularly limited and which may be adapted depending on the expected aim. Generally, they have a maximum thickness of about 1 μm, and generally a thickness ranging from 50 nm to 1 μm, preferably from 50 to 500 nm and more preferably from 50 to 150 nm.

The mesoporous coating of the invention may be a multilayered coating, i.e. be composed of several mesoporous layers directly deposited onto one another. In this case, the coating acting as a barrier to sebum is directly deposited onto the external mesoporous layer (the most distant from the substrate) of the mesoporous coating.

In one embodiment, the mesoporous coating forms a monolayered anti-reflection coating. When it comes as a monolayered anti-reflection coating, the mesoporous coating of the invention preferably has a thickness ranging from 80 to 130 nm, preferably from 90 to 120 nm, more preferably from 95 to 110 nm, so as to minimize reflection at a wavelength of about 540 nm, at which the eye sensitivity is maximum.

Although the coating's silica-based layer acting as a barrier to sebum may contribute to the efficiency of the anti-reflection stack, it is considered in the present application, because of the low thickness thereof, that it forms a separate layer not belonging to the anti-reflection coating, when the article of the invention comprises such coating.

The refractive index of the mesoporous coating of the invention is lower than or equal to 1.45, more preferably lower than or equal to 1.40. It thus forms a low refractive index-layer, after the removal of the pore-forming agent from the mesopores. The mesoporous coating may comprise several mesoporous layers.

In the present application, a layer is said to be a high refractive index-layer (HI) when the refractive index thereof is higher than 1.55, preferably higher than or equal to 1.6, more preferably higher than or equal to 1.8 and even more preferably higher than or equal to 2.0. A layer is said to be a low refractive index-layer (LI) when the refractive index thereof is lower than or equal to 1.55, preferably lower than or equal to 1.50, more preferably lower than or equal to 1.45. Unless otherwise mentioned, the refractive indices to which it is referred to in the present invention are expressed at 25° C. for a wavelength of 630 nm.

The mesoporous coating is more preferably deposited onto an abrasion-resistant layer having a thickness higher than 1 micrometer, preferably higher than or equal to 2 micrometers, and a high refractive index (generally higher than or equal to 1.55, more preferably higher than or equal to 1.60).

In one embodiment of the invention, the mesoporous coating is formed on a high refractive index-layer, that was beforehand deposited onto the substrate, and thus forms a low refractive index-layer of a bilayered anti-reflection coating or a multilayered anti-reflection coating i.e. of more than two layers, as described in the patent application WO 2006/021698. The HI layer is preferably obtained through curing of a composition comprising a hydrolyzate of alkoxysilane, especially epoxysilane, more preferably epoxytrialkoxysilane and of high refractive index colloids or precursors thereof. In particular, the colloids may be colloids of TiO₂.ZrO₂.Sb₂O₅, SnO₂.WO₃, Al₂O₃.

Such HI layer has a thickness varying more preferably from 10 to 200 nm, more preferably from 80 to 150 nm.

Such HI layer may also be a HI layer of an anti-reflection stack comprising alternating high refractive index layers and low refractive index layers, in particular when the anti-reflection stack does possess a plurality of layers.

In one embodiment, the article of the invention comprises a bilayered anti-reflection coating composed of a high refractive index-layer (generally n=1.7 to 1.8) and of a mesoporous layer according to the invention (generally n=1.3 to 1.4), coated with a coating acting as a barrier to sebum, preferably a silica-based layer according to the invention (generally n=1.45 to 1.55).

Preferably, the mean reflection coefficient in the visible range Rₘ (400-700 nm) and/or the mean light reflection coefficient Rᵥ (weighted average of spectral reflection over the whole visible spectrum between 380 and 780 nm) of an article of the invention is or are less than 2% per article face, more preferably less than 1% per article face and even more preferably less than 0.75% per article face. The persons skilled in the art will adapt accordingly the thickness values and indices for the various layers. In the present application, the “mean reflection coefficient” Rₘ and the “light reflection coefficient” Rᵥ are such as defined in the ISO 13666:1998 Standard and measured according to the ISO 8980-4 Standard.

In the present application, the coating acting as a barrier to sebum will be commonly referred to as being the “barrier layer” or the “layer impermeable to sebum”.

Sebum to which the coating of the invention makes barrier contains as a main component oleic acid, whatever its origin, natural or synthetic. Natural sebum generally contains from 20 to 30% of oleic acid.

The coating acting as a barrier to sebum comprises with at least one silica-based layer comprising at least 90% by weight of silica, relative to the layer total weight, preferably at least 95% by weight of silica. In its most preferred embodiment, it comprises 100% by weight of silica.

Should the silica-based layer not only comprise silica, the other materials to be included would be preferably dielectric materials such as metal oxides, in particular alumina (Al₂O₃). Fluorine-doped silica can also be employed.

Preferably, combinations of silica with other compounds should lead to a refractive index for the resulting silica-based layer being ≦1.55.

When a silica-based layer comprising a mixture of SiO₂ and Al₂O₃ is used, it comprises more preferably from 1 to 10%, more preferably from 1 to 8% and even more preferably from 1 to 5% by weight Al₂O₃ as compared to the SiO₂+Al₂O₃ total weight in such layer. For instance, SiO₂ doped with 4% or less Al₂O₃ by weight, or SiO₂ doped with 8% Al₂O₃ may be employed. Commercially available SiO₂/Al₂O₃ mixtures may be used, such as LIMA® marketed by Umicore Materials AG (refractive index n=1.48-1.50 at 550 nm), or the L5® substance marketed by Merck KGaA (refractive index n=1.48 at 500 nm).

In one embodiment of the invention, the coating acting as a barrier to sebum consists in said silica-based layer.

However, the coating acting as a barrier to sebum may also be a multilayered coating, comprising other layers in addition to the silica-based layer, for instance several mineral layers, preferably based on silica, and/or an anti-fouling coating used as the outer layer of the stack.

In one embodiment, the coating acting as a barrier to sebum comprises said silica-based layer, coated with an anti-fouling coating.

Using a few-nanometer thick anti-fouling coating as a barrier layer component improves its efficiency against sebum-mediated contamination of the mesoporous coating and makes it possible to use a thinner silica-based layer than without any anti-fouling coating, while obtaining similar performances as regards protection.

Without wishing to be bound by any theory, the inventors think that such an improvement is due to adding a further layer thickness which limits sebum penetration thanks to its oleophobic surface properties.

Anti-fouling coatings, also called hydrophobic and/or oleophobic coatings or top-coats, reduce the sensitivity of the article to fouling, for instance towards greasy deposits. As is known, such hydrophobic and/or oleophobic external coatings are obtained by applying onto the anti-reflection coating surface, compounds which reduce the surface energy of the article.

Anti-fouling coatings to be used are more preferably those described in the patent application WO 2009/047426, incorporated herein by reference. They are mostly prepared from polymerizable compositions containing compounds based on silanes or silazanes and bearing fluorinated moieties (fluorosilanes or fluorosilazanes), especially perfluorocarbon or perfluoropolyether moieties.

Commercially available compositions to be suitably used for preparing hydrophobic and/or oleophobic coatings are either KY130® (having the formula given in the patent JP 2005-187936) or OPTOOL DSX®, marketed by DAIKIN INDUSTRIES (having the formula given in the U.S. Pat. No. 6,183,872).

The application of compounds reducing the surface energy of the article is classically effected through dip coating in a solution of said compounds, through spin coating or chemical vapor deposition.

Generally, the anti-fouling coating has a thickness which is lower than 10 nm, preferably ranging from 2 to 10 nm, more preferably from 2 to 5 nm, still more preferably ranging from 2 to 4 nm.

Preferably, the hydrophobic and/or oleophobic external coating has a surface energy equal to or lower than 14 mJ/m², preferably equal to or lower than 13 mJ/m², more preferably equal to or lower than 12 mJ/m². Compounds with such a surface energy are generally alkoxysilanes comprising perfluoropolyether chain members.

The coating acting as a barrier to sebum has a thickness that is lower than or equal to 20 nm, but higher than or equal to 5 nm. If the thickness of the coating acting as a barrier to sebum becomes too large, it may become detrimental to the properties of the mesoporous coating, in particular it may affect the possible anti-reflective properties by increasing the level of reflection. If the thickness of the coating acting as a barrier to sebum becomes too small, it may on the contrary become permeable to sebum.

The minimum thickness for the coating acting as a barrier to sebum depends on the deposition conditions of such coating, and in particular on the deposition conditions of its silica-based layer. Thus, when proceeding to the ion-assisted deposition (described hereunder), a thinner coating acting as a barrier to sebum may be used, for a similar protection, because of its higher density.

The inventors also observed that the physical continuity of the barrier layer impermeable to sebum of the invention was crucial to preserve pores from the sebum penetration. If the barrier layer suffers from scratches, protection cannot be ensured anymore and sebum does impregnate through the opening.

The silica-based layer of the invention has a thickness ranging from 5 to 20 nm, preferably from 8 to 20 nm, more preferably from 10 to 20 nm. In one embodiment, its thickness is higher than 10 nm. When the thickness of said silica-based layer is lower than 10 nm, the article comprises in addition, preferably, an anti-fouling coating having a thickness of at least 2 nm.

When the coating acting as a barrier to sebum constituted an anti-fouling coating, the silica-based layer of the invention has preferably a thickness higher than or equal to 8 nm, more preferably higher than or equal to 10 nm.

When the coating acting as a barrier to sebum is comprised of the silica-based layer of the invention, the latter preferably has a thickness ranging from 10 to 20 nm.

Preferably, the silica-based layer of the coating acting as a barrier to sebum is directly deposited onto the mesoporous coating, that is to say it does contact the latter. Such layer must absolutely be deposited by physical vapor deposition (PVD), preferably by evaporation under vacuum or by cathode sputtering, most preferably by evaporation under vacuum.

On the contrary, for instance upon forming a silica-based layer by means of a liquid-mediated method (dipping, spin coating . . . ), a permeable layer is obtained, which does not allow to prevent sebum from penetrating into the mesoporous coating.

A possible application of the invention is therefore also envisaged in the microelectronics field.

The inventors did notice that depositing a coating acting as a barrier to sebum by physical vapor deposition onto the mesoporous coating does not modify (or very little) the refractive index and the dielectric constant of the latter, which means that the pores of the mesoporous coating are not filled with the deposition under vacuum of the barrier layer. A PVD-mediated deposition of the barrier layer thus enables to preserve the low refractive index property and more generally the low dielectric constant property of the underlying mesoporous coating.

In addition, a deposition effected by a treatment under vacuum makes it possible to control the thickness of the barrier layer at the level of a few nanometers, which is not the case with depositions through a liquid-mediated method. To control these thicknesses is crucial, especially when making anti-reflection stacks. When the coating acting as a barrier to sebum comprises other mineral layers than the silica-based layer of the invention, the latter ones are preferably deposited by physical vapor deposition.

A treatment step using energetic species such as previously described may be carried out simultaneously with the deposition of one or more of the various layers of the stack, especially under ionic assistance, preferably using oxygen ions.

The Ion-assisted Deposition method (IAD) is described in particular in the patent application WO2009/004222.

Ion-assisted evaporation consists in depositing onto a substrate a film of material by evaporation under vacuum by simultaneously bombarding the surface of the layer being formed with a positive ion beam delivered by an ion gun, said positive ions being particles constituted of gas atoms from which one or more electron(s) was or were extracted, formed from a rare gas, from oxygen or from a mixture of two or more of such gases. The ion bombardment generates an atomic rearrangement in the layer being deposited, which makes it possible to compact the same while it is being formed. In addition to such compaction, IAD enables to improve the adhesion of the deposited layers and to slightly increase their refractive index.

Thus, as an option, the layer acting as a barrier to sebum, and preferably the silica-based layer of the invention, is deposited by means of the Ion-assisted Deposition method (IAD). The deposition of this layer under ion assistance is preferably chosen when the thickness thereof is lower than 10 nm.

The present invention will be illustrated, without limitation, by means of the following examples. Unless otherwise mentioned, refractive indices are indicated for a wavelength of 630 nm and T=20-25° C.

### EXAMPLES

### A) Reactants and Equipments Used for Synthesizing the Mesoporous Coatings

TEOS, of formula Si(OC₂H₅)₄, was used as an inorganic precursor agent of formula (I), CTAB of formula C₁₆H₃₃N(CH₃)₃Br was used as a surface-active pore-forming agent and hexamethyldisilazane (HMDS) was used as a hydrophobic reactive compound.

Sols were prepared by using absolute ethanol as an organic solvent and a hydrochloric acid aqueous solution diluted at 0.1 M (so as to obtain a pH=1.25) as a hydrolysis catalyst.

The coatings were deposited onto lenses including a lens substrate MR8 (thiourethan resin with a refractive index of 1.59) or ORMA® ESSILOR (CR-39®), with a refractive index of 1.50, a thickness of 1.1 mm, with a radius of curvature ranging from 80 to 180 mm and with a diameter ranging from 65 to 70 mm, or onto silicon substrates (wafers). MR8 or ORMA® lenses were coated with the abrasion-resistant and scratch-resistant coating disclosed in example 3 of the European patent EP 0614957 (with a refractive index of 1.48 and a thickness of 3.5 μm), based on GLYMO, DMDES, colloidal silica and aluminium acetylacetonate, or with the abrasion-resistant and/or anti-scratch coating comprising a polysiloxane matrix and a high index colloid (with a refractive index of 1.60 and a thickness of 3.5 μm). In examples 5 and 6, a layer of a high refractive index of anti-reflection coating obtained from a composition comprising a GLYMO hydrolyzate and a titanium colloid under the form of rutile (index of the hardened composition: n˜1.76) with a thickness of 150 nm was deposited onto the abrasion-resistant coating.

### B) Preparation of Mesoporous Coatings Having a Matrix Comprising —Si—O—Si— Chain Members that was Made Hydrophobic Through Post-Synthetic Grafting

The precursor sol was prepared by mixing together reagents and solvents in the following molar ratios: TEOS (50 mL), EtOH (50 mL), HCl (0.1N, 20.5 mL). The whole mixture was heated for 1 h at 60° C. to hydrolyze the silanes. After cooling, 120.5 mL of a stock solution having a solid content of 14.5% by weight was obtained. 15 mL of this solution were then diluted through a solution of 1.02 g of CTAB in 100 mL ethanol, leading to a solution having a solid content of 2.5% by weight, wherein the CTAB/TEOS molar ratio was equal to 0.1. It was set under stirring overnight prior to being deposited through spin coating onto the organic lens ORMA® or MR8 such as described hereunder.

The film was thereafter submitted to a heat treatment intended to advance the polymerization degree of the lattice (consolidation). The film-coated substrate obtained in paragraph 2 above was consolidated through a heat treatment carried out in an oven at 75° C. for 15 minutes, then at 100° C. for 3 hours, then the pore-forming agent was removed through extraction by placing the cured film-coated substrate in the vessel of an isopropanol-containing Elmasonic sonicator at room temperature for 15 min.

The substrate coated with the mesoporous film was then introduced for 15 minutes in the ultrasound-generating vessel of an Elmasonic sonicator, containing hexamethyl disilazane (HMDS), at room temperature. The lenses were then rinsed with isopropyl alcohol so as to remove HMDS in excess. Such post-synthetic hydrophobation step has been described in more detail in the patent applications WO 2007088312 and WO 2006021698. It enabled recovering a mesoporous layer of about 100 nm thickness and having a refractive index ranging from 1.31 to 1.33. The thus coated substrates were stored in an oven heated at 60° C.

The optical articles of examples 1-4 did possess a monolayered anti-reflection coating, whereas the optical articles of examples 5-6 did possess a bilayered anti-reflection coating (HI layer/mesoporous layer).

### C) Deposition of the Coating Making a Barrier to Sebum

The coatings acting as barriers to sebum used in the examples of the invention comprised a silica layer (SiO₂, refractive index 1.47) and optionally a fluorinated anti-fouling coating (Optool DSX®).

These coatings were deposited through evaporation in a closed vessel under vacuum on a deposition machine MC380 or 1200DLF Satis, without carrying out any prior activating treatment of the mesoporous coating's surface. Deposition of SiO₂ was effected through evaporation by means of an electron gun (deposition mean pressure: 3.55.10⁻³ Pa, deposition rate: 0.15 nm/s, electron gun power: 20%). The anti-fouling coating was deposited by using a heat source produced by Joule effect (deposition mean pressure: 1.84.10⁻³ Pa, deposition rate: 0.40 nm/s, Joule effect power: 12%).

### D) Comparative Examples

In the comparative examples C1 to C10, the silica layer deposited by evaporating the silica of the coating acting as a barrier to sebum was replaced by a layer of MgF₂, by a silica layer having a thickness 5 nm deposited by evaporation, by a layer of Optool DSX®, or removed. The deposition of MgF₂ was effected through cold evaporation with an electron gun in the same conditions as for silica.

In the comparative examples C11 and C12, the silica barrier layer has not been deposited through physical vapor deposition but through a liquid-mediated method.

In comparative example C11, the barrier layer was a silica layer obtained using a sol-gel method, through tetramethoxysilane (TMOS) condensation, as follows:

In a beaker under stirring were introduced tetramethoxysilane (12.58 g) and ethanol (10 g). Stirring was continued for 2-3 minutes and hydrochloric acid 0.1 N (7.41 g) was added thereto. Stirring was continued for further 30 minutes and 10 g of ethanol were added. The solution, which had a solid content of 12.8% by weight, was diluted so as to obtain a solid content of 1% by weight. Such solution was then deposited by spin coating onto the mesoporous coating (2500 rpm, 20 s, 2000 acc), then polymerized for 30 minutes at 120° C.

In the comparative example C12, the barrier layer was a silica layer obtained through a sol-gel method, by condensating tetramethoxysilane (TMOS) in the presence of a silica-containing colloid (NALCO® 1034A, average size of the silica nanoparticles: 20 nm) and aluminium acetylacetonate. This layer was prepared according to the procedure given in the patent application WO 00/10934, in examples 1 and 4.

### E) Description of the Optical Articles of the Invention or Comparative Optical Articles

### Substrate/Abrasion-Resistant Coating/Mesoporous Coating/Barrier Layer Stacks

Example 1: 10 nm-thick silica barrier layer (deposition through evaporation)
Example 2: 8 nm-thick silica barrier layer (deposition through evaporation)
Example 3: 6 nm-thick silica barrier layer (deposition through evaporation)+2 nm-thick Optool DSX® layer
Example 4: 10 nm-thick silica barrier layer (deposition through evaporation)+2 nm-thick Optool DSX® layer
Comparative example C1: no barrier layer
Comparative example C2: 2 nm-thick silica barrier layer (deposition through evaporation)
Comparative example C3: 4 nm-thick silica barrier layer (deposition through evaporation)
Comparative examples C4 to C7: 2 nm-, 4 nm-, 6 nm- and 8 nm-thick MgF₂ barrier layers
Comparative example C8: 2 nm-thick Optool DSX® barrier layer
Comparative example C9: 2 nm-thick silica barrier layer (deposition through evaporation)+2 nm-thick Optool DSX® layer
Comparative example C10: 4 nm-thick silica barrier layer (deposition through evaporation)+2 nm-thick Optool DSX® layer
Comparative example C11: 15 nm-thick silica barrier layer (deposition through spin coating of hydrolyzed TMOS)
Comparative example C12: 20 nm-thick silica and silica colloids barrier layer (deposition through spin coating of hydrolyzed TMOS+NALCO® 1034A)

### Substrate/Abrasion-Resistant Coating/HI Layer/Mesoporous Coating/Barrier Layer Stacks

Example 5: 8 nm-thick silica barrier layer (deposition through evaporation)+2 nm-thick Optool DSX® layer
Example 6: 10 nm-thick silica barrier layer (deposition through evaporation)+2 nm-thick Optool DSX® layer
Evaluation of the Barrier Layer Efficiency after Deposition of Synthetic Sebum

Synthetic sebum, substantially comprised of oleic acid, was deposited by dabbing onto the surface of the test articles. The impregnation time, in other words the time left to sebum for optionally contaminating the mesoporous layer prior to wiping and/or washing of the sebum deposit with soapy water, did range from 24 h to 3 days. The articles were then characterized through infrared measurements, ellipsometry or optical microscopy, so as to evaluate the porosity protection efficiency by the barrier layer.

### F) Characterization Means

The optical articles prepared were analyzed by using the following methods:
Reflection spectrum (SMR).
Fourier transform Infrared spectroscopy (IR) (apparatus Bruker Vector 33). For each spectrum, 15 accumulations were effected to a 4 cm⁻¹ precision. Within the 2500-3300 cm⁻¹ area, the IR spectrum of synthetic sebum had two characteristic peaks at 2914 and 2850 cm⁻¹ corresponding to the vibration bands of the CH₂ chains of the sebum compounds. Monitoring how these vibration bands evolved did enable to evaluate the sebum-mediated pollution of the mesoporous coating porosity, within the detection limits of the IR spectroscope.
Optical microscopy: Mesoporous layers were deposited onto biplane substrates so as to follow through optical microscopy the fouling impregnation in the pores. Reflection pictures were taken with a magnifying power varying from (×25) to (×200).
Multiwavelength ellipsometry (Woolman), to calculate the refractive indices according to the Cauchy and EMA models:

For this study, the mesoporous layers described above (HMDS-mediated hydrophobation, thickness 100 nm) were deposited onto wafers of silicon. Measurements of the refractive index were conducted through ellipsometry, before and after the deposition under vacuum of a round 10 nm-thick SiO₂ layer. The values are summarized in table 1. The models used (Cauchy and EMA) assumed the presence of a single layer, which was an approximation since a silica layer deposition had been effected. The mean square error value (MSE) did reflect the quality of the confidence measure. A value lower than 50 is generally considered as acceptable.

TABLE 1

| | Cauchy model | | | EMA model | | | |
|---|---|---|---|---|---|---|---|
| | Refractive | Thickness | | Refractive | Thickness | Porosity | |
| Configuration | index | (nm) | MSE | index | (nm) | (%) | MSE |
| Mesoporous coating | 1.315 | 106 | 10.58 | 1.317 | 106 | 29.6 | 12.5 |
| Mesoporous coating + | 1.331 | 117 | 16.5 | 1.333 | 117.8 | 26.3 | 20 |
| SiO₂ 10 nm | | | | | | | |
| Mesoporous coating + | 1.3309 | 127 | 20 | 1.331 | 127.8 | 26.7 | 23.46 |
| SiO₂ 10 nm + | | | | | | | |
| Optool DSX ® 2 nm | | | | | | | |

Table 1 shows a very slight refractive index variation after deposition of the SiO₂ layer. These measures also demonstrate that the pores of the mesoporous coating were not or little filled with the silica layer deposition.

When both models assumed the presence of a single layer, the measurement integrated the refractive indices of both layers to give an average weighted through the respective thicknesses of the various layers. Thus, if calculating the thickness-weighted refractive index assuming that 1) the refractive index of the mesoporous layer was 1.315 for a thickness of 106 nm and that 2) the refractive index of the silica layer was 1.48 for a thickness of 11 nm, a final average weighted refractive index of (1.315×106+1.48×11)/(106+11)=1.3305 was obtained. This value did correspond to the refractive index measured by means of the ellipsometer with a monolayer model.

### G) Results

The three characterization methods used enabled to demonstrate the contamination through sebum of a porous layer not coated with a barrier layer of the invention and the non contamination through sebum of a porous layer coated with a barrier layer according to the invention.

### Optical Microscopy:

the presence of sebum into the porosity was observed through optical microscopy (magnification ×25) on the comparative articles. The fouling impregnation in the porosity was clearly visible after an impregnation time of only 15 minutes. After a partial wiping of the article surface, residual impregnation stains could be clearly identified.

### Infrared Spectroscopy:

the presence of sebum into the porosity could be observed on the comparative articles through infrared spectroscopy. Spectra obtained 24 h after fouling deposition and thereafter wiping did reveal the presence of sebum in the pores, even after washing with soapy water (characteristic peaks of sebum at 2914 and 2850 cm⁻¹). Washing with soapy water only enabled to remove the sebum present on the surface of the article.

### Variation of the Refractive Index:

Depositions of synthetic sebum were carried out on the test articles. Refractive index measurements were effected through ellipsometry after an impregnation period of 24 h, followed with a wiping and a washing with soapy water.

In the absence of any barrier layer (the mesoporous coating formed in this case the outer layer of the stack), in the presence of an excessively thin silica barrier layer (<5 nm) provided or not with an Optool DSX® layer, or in the presence of a MgF₂ barrier layer (whatever its thickness, from 2 to 8 nm) or a barrier layer comprised of Optool DSX® (example C8), it could be observed that the refractive index of the mesoporous coating increased from a refractive index range of 1.31-1.33 to a refractive index range of 1.37-1.46, i.e. a refractive index variation of at least 0.04 (see Table 2). The layers mentioned hereabove thus did not form layers preventing efficiently sebum from penetrating into the porosity of the mesoporous coating.

Example C11 shows that a silica layer resulting from the condensation of TMOS (sol-gel method) did not allow to protect the underlying mesoporous coating against sebum penetration. Example C12 shows that the presence of colloids did not allow to improve the protective properties of a silica barrier layer formed by means of a liquid-mediated method.

It should be noted that the deposition of these silica layers by means of a liquid-mediated method did not fill, or at least very little, the porosity of the underlying mesoporous layer. Indeed, the refractive index measured (n=1.33), i.e. the weighted average of the barrier layer index and of the mesoporous layer index, implied a mesoporous coating index of about 1.308 corresponding to that of the mesoporous layer +HDMS without any overlayer (example 1).

As for the coatings of the invention acting as barriers to sebum (examples 1-6), no impregnation stain could be identified through optical microscopy. No residual impregnation could be identified after a partial wiping of the article surfaces either. The infrared spectra conducted 24 h after deposition of fouling, then wiping, did reveal the absence of sebum in the pores of the articles of the invention.

Table 2 shows that the refractive index variation of the mesoporous coating of the optical article, after impregnation of the optical article surfaces with synthetic sebum, then wiping, was much lower with the optical articles of the invention.

TABLE 2

| | | | n after wiping + | |
|---|---|---|---|---|
| | Initial | n after | washing with | |
| Example | n | wiping | soapy water | Δn |
| C1 | 1.308 | — | 1.397 | 0.089 |
| C2 | 1.327 | 1.404 | 1.398 | 0.071 |
| C3 | 1.335 | 1.374 | 1.370 | 0.035 |
| C4 | 1.322 | 1.447 | — | 0.125 |
| C5 | 1.319 | 1.438 | — | 0.119 |
| C6 | 1.319 | 1.456 | — | 0.137 |
| C7 | 1.319 | 1.436 | — | 0.117 |
| C8 | 1.333 | 1.443 | 1.396 | 0.063 |
| C9 | 1.325 | 1.368 | 1.366 | 0.041 |
| C10 | 1.333 | 1.358 | 1.366 | 0.033 |
| C11 | 1.335 | — | 1.464 | 0.129 |
| C12 | 1.345 | — | 1.397 | 0.052 |
| 1 | 1.334 | — | 1.342 | 0.008 |
| 2 | 1.329 | 1.355 | 1.343 | 0.014 |
| 3 | 1.347 | 1.356 | 1.357 | 0.010 |
| 4 | 1.332 | — | 1.338 | 0.006 |

Table 3 indicates the reflection performances of some articles of the invention, measured by means of a spectrophotometer, immediately after their preparation (without contacting synthetic sebum):

TABLE 3

| Example | h (°) | C* | Rₘ (%) | R_{V} (%) |
|---|---|---|---|---|
| 2 | 302 | 9.4 | 0.7 | 0.43 |
| 4 | 282 | 17.5 | 1.14 | 0.67 |
| 5 | 239 | 7.2 | 0.56 | 0.47 |
| 6 | 251 | 9.4 | 0.68 | 0.54 |

After a 24 hour-contact with synthetic sebum, then wiping:

| | | | | |
|---|---|---|---|---|
| 4 | 283 | 17.5 | 1.12 | 0.67 |
| 5 | 238 | 7.2 | 0.57 | 0.47 |
| 6 | 247 | 9.3 | 0.69 | 0.54 |

After a 24 hour-contact with synthetic sebum,
then wiping and washing with soapy water:

| | | | | |
|---|---|---|---|---|
| 4 | 283 | 17.4 | 1.10 | 0.64 |
| 5 | 236 | 6.7 | 0.53 | 0.65 |
| 6 | 246 | 8.9 | 0.67 | 0.45 |

The coatings of the invention acting as barriers to sebum thus provide the mesoporous coating with an efficient protection against impregnation with sebum, for at least 24 hours of a continuous exposure to synthetic sebum.

1.-14. (canceled)

15. An article comprising a substrate, having a main surface coated with a mesoporous coating and a coating acting as a barrier to sebum having a thickness lower than or equal to 20 nm directly deposited onto the mesoporous coating, wherein the coating acting as a barrier to sebum comprises at least one silica-based layer further defined as:
having a thickness of at least 5 nm;
comprising at least 90% by weight of silica, relative to the layer total weight; and
having been deposited by physical vapor deposition.

16. The article of claim 15, wherein the silica-based layer is in contact with the mesoporous coating.

17. The article of claim 15, wherein the coating acting as a barrier to sebum comprises an anti-fouling coating.

18. The article of claim 17, wherein the anti-fouling coating is obtained from a polymerizable composition containing silanes or silazanes bearing fluorinated moieties.

19. The article of claim 17, wherein the silica-based layer has a thickness higher than or equal to 8 nm.

20. The article of claim 17, wherein the anti-fouling coating has a thickness ranging from 2 to 10 nm.

21. The article of claim 15, wherein the coating acting as a barrier to sebum consists of said silica-based layer.

22. The article of claim 15, wherein the silica-based layer has a thickness higher than 10 nm.

23. The article of claim 15, wherein the article is an optical lens.

24. The article of claim 23, wherein the optical lens is an ophthalmic lens.

25. The article of claim 15, wherein the mesoporous coating is a layer of a monolayered or multilayered anti-reflection coating.

26. The article of claim 15, wherein the mesoporous coating is a sol-gel coating with a matrix containing —Si—O—Si— chain members.

27. A method for preparing an article of claim 15, wherein the main surface that is coated with a mesoporous coating has a refractive index which is stable over time, comprising forming by physical vapor deposition, directly onto said mesoporous coating, a coating acting as a barrier to sebum having a thickness lower than or equal to 20 nm that comprises at least one silica-based layer further defined as:
having a thickness of at least 5 nm;
comprising at least 90% by weight of silica, relative to the layer total weight; and
having been deposited by physical vapor deposition.

28. The method of claim 27, wherein the silica-based layer of the coating acting as a barrier to sebum is deposited by evaporation under vacuum.

29. A method comprising:
obtaining an article comprising a substrate, having a main surface coated with a mesoporous coating and a coating acting as a barrier to sebum having a thickness lower than or equal to 20 nm directly deposited onto the mesoporous coating, wherein the coating acting as a barrier to sebum comprises at least one silica-based layer further defined as:
having a thickness of at least 5 nm;
comprising at least 90% by weight of silica, relative to the layer total weight; and
having been deposited by physical vapor deposition; and
using said coating acting as a barrier to sebum for preventing the penetration of sebum into the porosity of said mesoporous coating.
